(19) United States
(12) Patent Application Publication
(10) Pub. No.: US 2021/0230752 A1
(43) Pub. Date: Jul. 29, 2021

(54) Corrosion Inhibitor Apparatus for Land Vehicles

(71) Applicant: Richard L. Klopp, Bethel, PA (US)

(72) Inventor: Richard L. Klopp, Bethel, PA (US)

(21) Appl. No.: 17/140,015

(22) Filed: Jan. 1, 2021

Related U.S. Application Data
(60) Provisional application No. 62/965,421, filed on Jan. 24, 2020.

(51) Int. Cl. C23F 13/00

(52) U.S. Cl. CPC C23F 13/005; B62D 29/008

(57) ABSTRACT

A sacrificial metal component, such as a zinc bar, is mounted on the frame of a land vehicle to reduce the corrosion of the frame of the land vehicle. The zinc bar is mounted on the frame in a manner to electrically couple the zinc bar to the land vehicle to promote the sacrificial nature of the zinc bar. The zinc bar can be mounted on a metal bracket secured to the frame of the land vehicle by metal fasteners, molded with a steel mounting strap that can be secured to the frame of the land vehicle by metal fasteners, or simply be detachably connected to the zinc bar and to the frame of the land vehicle, or alternatively, attached directly to the frame of the land vehicle. With reduction in size, the zinc bar will need to be replaced for continued operation.

### CROSS-REFERENCE TO RELATED APPLICATIONS

This application claims domestic priority on U.S. Provisional patent Application Ser. No. 62/965,421, filed on Jan. 20, 2020, the content of which is incorporated herein by reference.

### FIELD OF THE INVENTION

The invention disclosed in this application is directed generally to an apparatus for controlling corrosion in land vehicles and, more particularly, is relates to the placement of zinc bars attached to the frames of land vehicles to provide a sacrificial metal and inhibit corrosion of the land vehicle.

### BACKGROUND OF THE INVENTION

Land vehicles, such as automobiles, pick-up trucks, semi-trucks and trailers, construction equipment, agricultural machinery, on-road and off-road vehicles, as examples, rust and corrode in northern states, primarily due to winter weather, and to humidity in the summer months. Vehicles in southern states typically rust from salt in the air, rather than salt applied to the roadways. The humidity in southern states increases the likelihood of corrosion even more so than the northern states. Rust and corrosion for commercial vehicles, such as semi-trucks and trailers is a significant problem due to the large financial investment in these vehicles. Accordingly, the owners spend a substantial amount of money repainting these vehicles every few years to inhibit the corrosion of the steel frames, sheet metal panels and other components.

Ocean-going ships have been known for decades to mount zinc bars to the exterior sides of the ship to reduce the occurrence of rust and corrosion. With these vessels being constantly exposed to saltwater, corrosion is a significant problem and the zinc bars have been successful in inhibiting rust on these ships. Zinc is the second lowest element on the Nobel Scale, lower than steel and aluminum, and thus, the zinc bars provide a sacrificial metal to inhibit the formation of corrosion of the steel structure of the ship. Conventional thinking has not expanded this practice to land vehicles because the land vehicles are not constantly subjected to exposure to saltwater, and are not in a corrosive environment, yet land vehicles continue to rust.

The use of dissimilar metals, such as steel, aluminum, and the combination of both steel and aluminum, to build trucks and trailers can cause each metal to rust or corrode faster than single metals. When you add electric current from the battery of the vehicle which is grounded, you cause electrolysis. Electrolysis enhances the corrosion process, especially when dissimilar metals are connected to each other.

Accordingly, it would be desirable to provide an apparatus that would be operable to inhibit and reduce the rusting or corrosion of land vehicles. In addition, it would be desirable to provide a convenient mounting mechanism for fastening zinc bars to a land vehicle frame in a manner that would provide a corrosion inhibitor for the land vehicle.

### SUMMARY OF THE INVENTION

It is an object of this invention to extend the operative life of land vehicles by reducing rusting of the metal components of the land vehicle.

It is another object of this invention to provide an apparatus for mounting sacrificial metal components to the frame of land vehicles.

It is an advantage of this invention that land vehicles remain serviceable for longer periods because of reduced rusting.

It is a feature of this invention that the sacrificial metal components are mounted to the frame of the land vehicle in a manner to be electrically coupled to the frame of the land vehicle.

It is another feature of this invention that the apparatus for mounting the sacrificial metal component is a metal bracket or strap which can be molded as part of the zinc anode and then bolted to the frame of the land vehicle.

It is another advantage of this invention that the sacrificial metal component is replaceable when reduced in size.

It is still another feature of this invention that the sacrificial metal component is a molded zinc bar formed with a metal strap that will permit a direct mounting of the zinc bar to the frame of the land vehicle.

It is another feature of this invention that the metal strap can be detachably connected to the zinc bar by metal fasteners, thus allowing the zinc bar to be easily replaced when worn.

It is yet another feature of this invention that the zinc bar can be attached directly to the frame of the land vehicle without the use of mounting straps or mounting brackets.

It is still another advantage of this invention that the zinc bar corrodes before the frame of the land vehicle corrodes.

It is still another object of this invention to provide a method and apparatus for extending the life of land vehicles that is effective in operation and inexpensive in application.

These and other objects, features and advantages will become known to one of ordinary skill in the art by providing a sacrificial metal component, such as a zinc bar, for mounting on the frame of a land vehicle to reduce the corrosion of the frame of the land vehicle. The zinc bar is mounted on the frame in a manner to provide a good metal to metal contact between the zinc bar and the land vehicle and to promote the sacrificial nature of the zinc bar. With reduction in size, the zinc bar will need to be replaced for continued operation.

### BRIEF DESCRIPTION OF THE DRAWINGS

The advantages of this invention will become apparent upon consideration of the following detailed disclosure of the invention, especially when taken in conjunction with the accompanying drawings wherein:

FIG. 1 is a schematic side elevational view of a tractor and trailer equipped with a corrosion inhibitor apparatus according to the principles of the instant invention;

FIG. 2 is a schematic side elevational view of a second exemplary land vehicle in the form of a construction machine, specifically a backhoe, equipped with the corrosion inhibitor apparatus according to the principles of the instant invention;

FIG. 3 is a schematic side elevational view of a third exemplary land vehicle in the form of an agricultural harvesting machine, specifically a combine harvester, equipped with the corrosion inhibitor apparatus according to the principles of the instant invention;

FIG. 4 is a schematic front elevational view of a first embodiment of the corrosion inhibitor apparatus adapted for mounting on land vehicles;

FIG. 5 is a schematic side elevational view of the corrosion inhibitor apparatus shown in FIG. 4;

FIG. 6 is a schematic front elevational view of a second embodiment of the corrosion inhibitor apparatus adapted for mounting on land vehicles;

FIG. 7 is a schematic side elevational view of the corrosion inhibitor apparatus shown in FIG. 6; and

FIG. 8 is a schematic front elevational view of a third embodiment of the corrosion inhibitor apparatus adapted for mounting on land vehicles;

FIG. 9 is a schematic side elevational view of the corrosion inhibitor apparatus shown in FIG. 8;

FIG. 10 is a top plan view of a fourth alternative embodiment of the corrosion inhibitor apparatus configured to be secured directly to the frame of the land vehicle;

FIG. 11 is a side elevational view of the fourth alternative embodiment of the corrosion inhibitor apparatus shown in FIG. 10;

FIG. 12 is an end view of the fourth alternative embodiment shown in FIG. 10;

FIG. 13 is a top plan view of fifth alternative embodiment of the corrosion inhibitor apparatus configured to be connected directly to the frame of the land vehicle;

FIG. 14 is a side elevational view of the fifth alternative embodiment of the corrosion inhibitor apparatus shown in FIG. 13;

FIG. 15 is a top plan view of a sixth alternative embodiment similar to the alternative embodiment shown in FIG. 12, but having a smaller sacrificial component;

FIG. 16 is a side elevational view of the sixth alternative embodiment of the corrosion inhibitor apparatus shown in FIG. 15;

FIG. 17 is an end view of the sixth alternative embodiment shown in FIG. 15;

FIG. 18 is a top plan view of a seventh alternative embodiment of the corrosion inhibitor apparatus, similar to that of FIG. 13 but having a smaller sacrificial component similar to that shown in the sixth embodiment shown in FIG. 15; and

FIG. 19 is a side elevational view of the seventh alternative embodiment.

### DETAILED DESCRIPTION OF THE PREFERRED EMBODIMENT

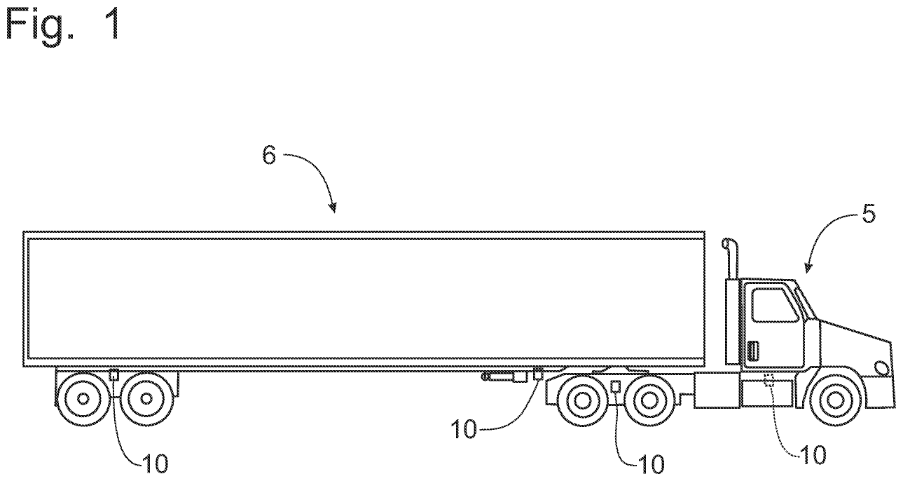

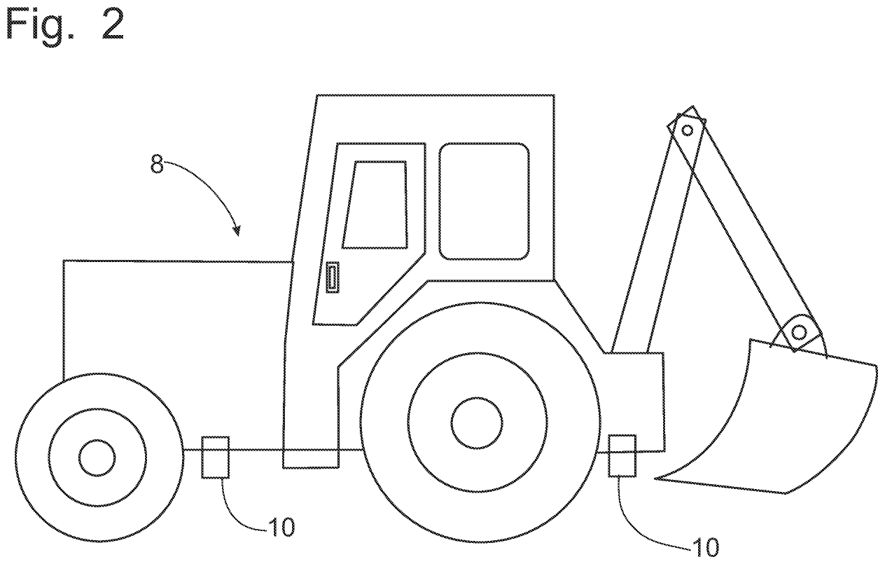

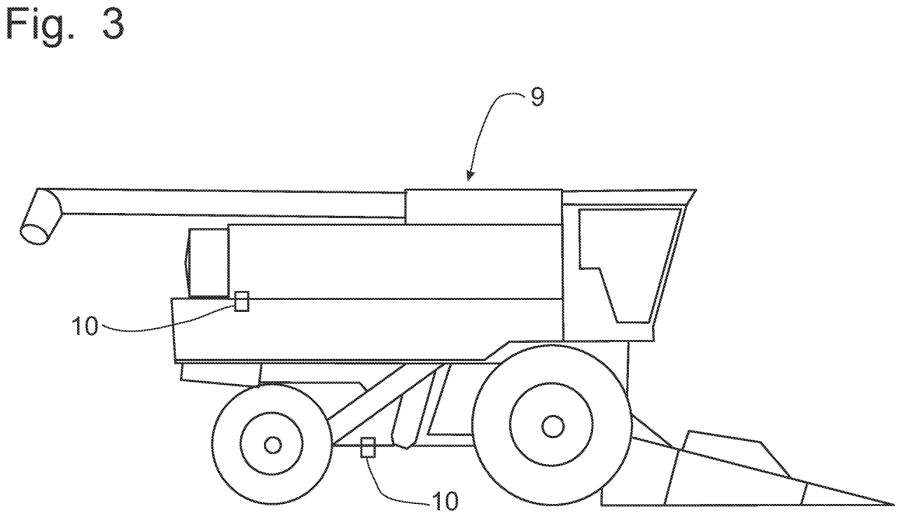

Referring to FIGS. 1-3, an exemplary sampling of different types of land vehicles that can utilize the apparatus according to the principles of the instant invention to inhibit and, thereby, reduce the extent of corrosion to the steel or aluminum components of the land vehicle. In FIG. 1, an eighteen wheel, commercial semi-tractor 5 and attached trailer 6 is schematically shown with corrosion inhibitor devices 10 mounted to the respective frames of the semi-tractor and trailer 5, 6. In FIG. 2, a backhoe 8 is chosen to symbolically represent construction machinery, which includes in the way of further examples, bulldozers, loaders, graders, cranes, and many other such construction machines. In FIG. 3, a combine harvester 9 is chosen to represent agricultural machinery which is exposed to moisture from the plants being harvester, even in dry southern states. Each of these representative machines and vehicles have corrosion inhibitor devices 10, as are described in greater detail below, mounted thereon to inhibit the formation of rust and corrosion on the vehicles or machine.

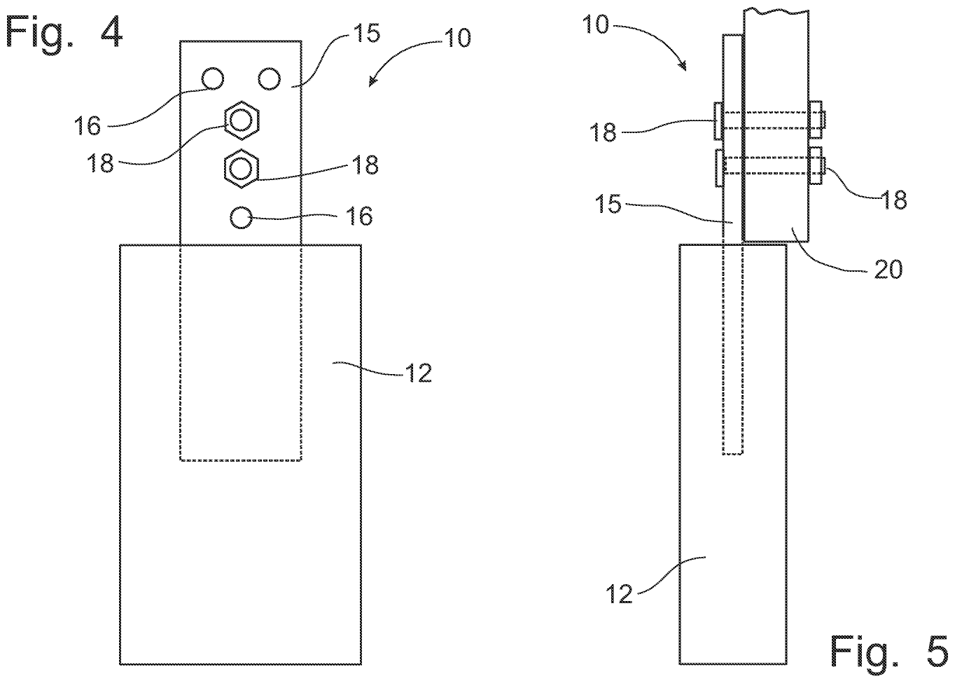

Referring to FIGS. 4 and 5, a first embodiment of the corrosion inhibitor device 10 can best be seen. The body 12 of the device 10 is a molded zinc bar. In the molding process, a mounting strap 15, preferably formed from steel, is incorporated integrally with the zinc bar body 12 such that the mounting strap 15 is an integrated component of the corrosion inhibitor device 10. The mounting strap 15 has a plurality of holes 16 formed therein to permit the passage of a fastener 18 through the mounting strap 15 to engage a frame member 20 or other steel or aluminum component of the vehicle or machine 5, 6, 8, 9 and permit the direct mounting of the mounting strap 15 to the land vehicle 5, 6, 8, 9.

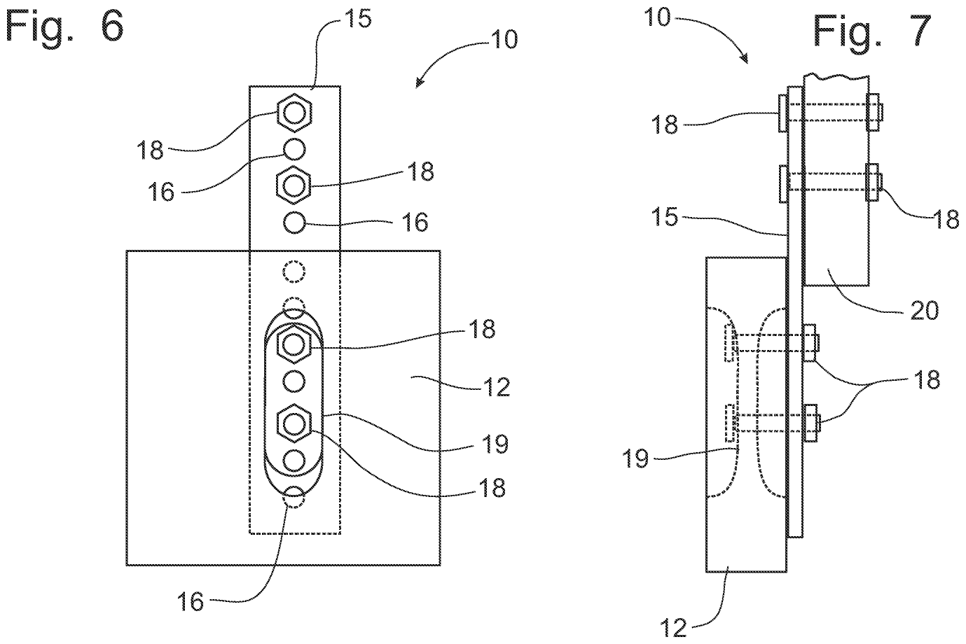

A second embodiment of the corrosion inhibitor device 10 is best seen in FIGS. 6 and 7. In this second embodiment of the corrosion inhibitor device 10, the mounting strap 15 and the zinc body 12 are separable components. The mounting strap 15 is formed with a plurality of holes 16 along the length of the mounting strap 15 to provide a convenient engagement with fasteners 18. One or more fasteners 18 will attach the upper end of the mounting strap 15 to the frame member 20, or other steel or aluminum component, of the vehicle or machine 5, 6, 8, 9, while a second set of fasteners 18 pass through an opening 19 in the body 12 of the device 10 and can extend through the mounting strap 15 so that the body 12 of the device 10 can be easily detached from the mounting strap 15 as will be described in greater detail below.

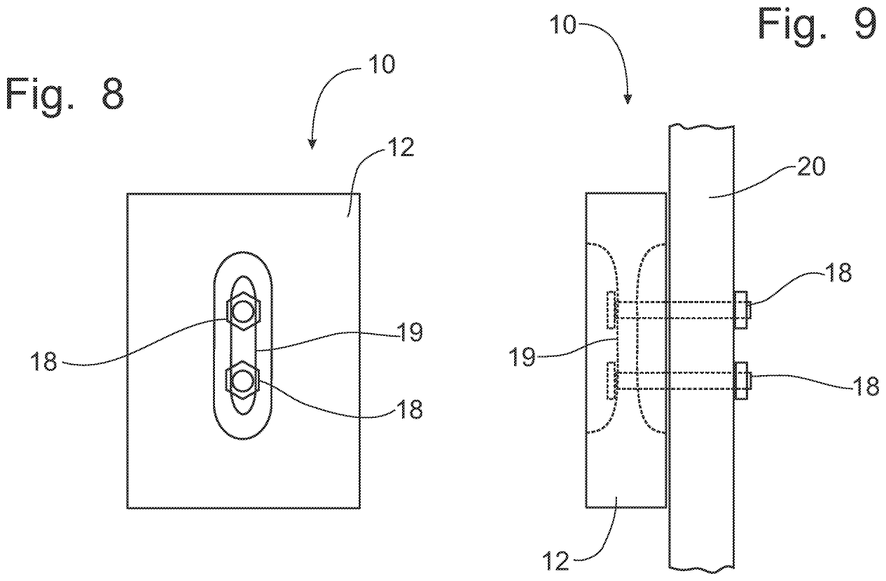

A third embodiment of corrosion inhibitor device 10 is best seen in FIGS. 8 and 9. In this third embodiment, the mounting strap is not utilized and the zinc body 12 is connected directly to the frame or other steel or aluminum component with fasteners 18 passing through the central opening 19 formed in the body 12 and engaging the frame 20. In this embodiment, the zinc body 12 is directly contacting the steel frame 20 or other steel or aluminum component.

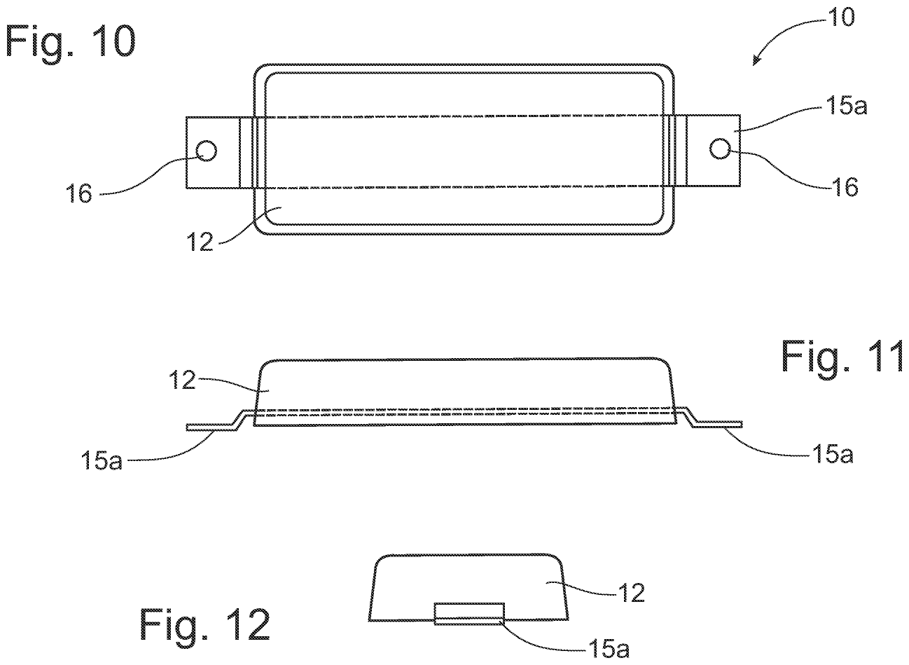

A fourth embodiment of the corrosion inhibitor device 10 is best seen in FIGS. 10-12. In this fourth embodiment of the corrosion inhibitor device 10, the mounting strap 15a is molded into the zinc body 12 and projects outwardly of both ends of the zinc body 12 to present a mounting tab at each end. The mounting strap 15a is formed with a hole 16 near the distal end of each mounting tab of the mounting strap 15a to permit the use of fasteners that will engage the frame of the land vehicle 5, 6, 8, 9 for operative engagement therewith. The zinc body 12 in this fourth embodiment is preferably of a size that provides a weight of about six pounds.

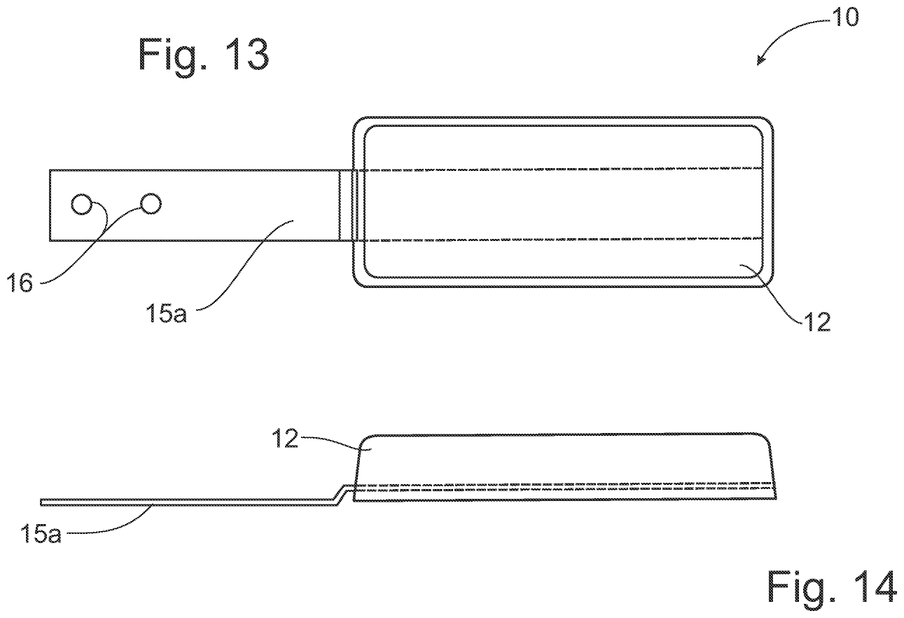

A fifth embodiment of the corrosion inhibitor device 10 is best seen in FIGS. 13 and 14. In this fifth embodiment of the corrosion inhibitor device 10, the mounting strap 15a is also molded into the zinc body 12, as is reflected in the dashed lines, but only projects outwardly from one end of the zinc body 12, similar to that depicted with respect to the second embodiment. The mounting strap 15a is formed with a pair of holes 16 near the distal end of the mounting strap 15a to permit the use of fasteners that will engage the frame of the land vehicle 5, 6, 8, 9 for operative engagement therewith. The zinc body 12 in this fourth embodiment is also preferably of a size that provides a weight of about six pounds.

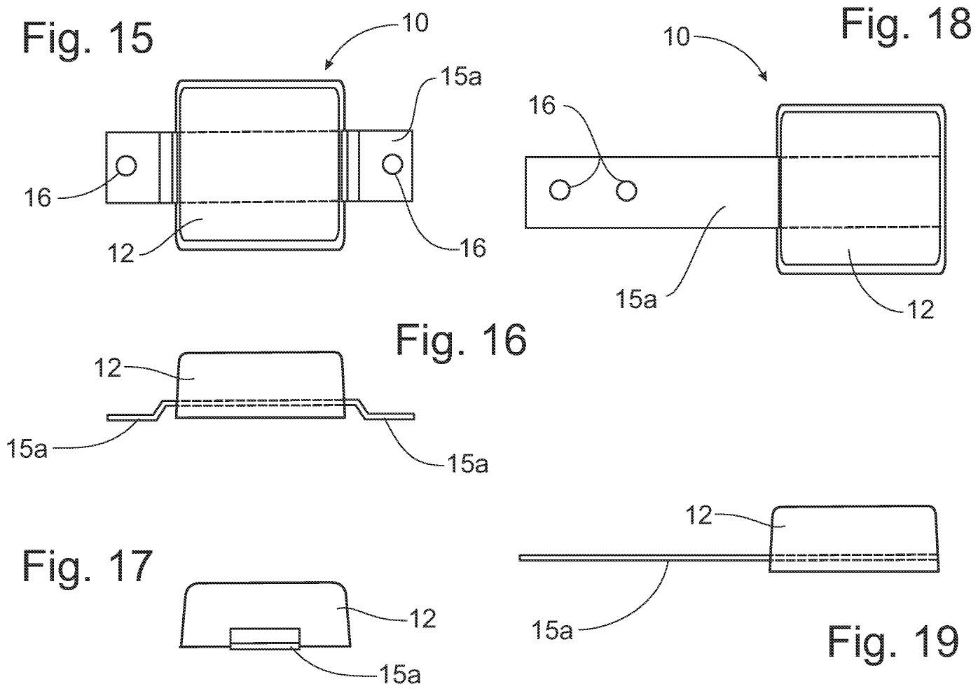

A sixth embodiment of the corrosion inhibitor device 10 is best seen in FIGS. 15-17. In this sixth embodiment of the corrosion inhibitor device 10, the mounting strap 15a is molded into the zinc body 12 and projects outwardly of both ends of the zinc body 12 to present a mounting tab at opposing ends, similar to that of the fourth embodiment described above. Each mounting tab is formed with a hole 16 to permit the use of fasteners that will engage the frame of the land vehicle 5, 6, 8, 9 for operative engagement therewith. The zinc body 12 in this sixth embodiment is configured to preferably be of a size that provides a weight of about three pounds.

A seventh embodiment of the corrosion inhibitor device 10 is best seen in FIGS. 18 and 19. In this seventh embodiment of the corrosion inhibitor device 10, the mounting strap 15a is also molded into the zinc body 12, as described above with respect to the fifth embodiment, but only projects outwardly from one end of the zinc body 12. The mounting strap 15a is formed with a pair of holes 16 near the distal end of the mounting strap 15a to permit the use of fasteners that will engage the frame of the land vehicle 5, 6, 8, 9 for operative engagement therewith. The zinc body 12 in this seventh embodiment is also preferably of a size that provides a weight of about three pounds.

In each of the seven embodiments, the body 12 is connected to the frame 20 in a manner that the body 12 has a good ground so that the electrical current can pass through and into the zinc body 12. As a result, the zinc body 12 establishes a sacrificial component that corrodes first, as the second lowermost element on the Nobel Scale, before much corrosion is encountered by the steel or aluminum components of the land vehicle. The zinc body 12 serves as a sacrificial member to accept the corrosion that would otherwise be attacking the steel or aluminum components. Accordingly, over time, the zinc body 12 will reduce in size due to the corrosion thereof. As a rule of thumb, when, the zinc body 12 is about half the size, i.e., weight, compared to the original size of the zinc body 12 when initially installed, the device 10 should be replaced.

The size of the zinc body 12 can change from one application to another. For commercial trucks and tractor-trailers, which are typically on the highway much of the time through all kinds of weather, a zinc body 12 weighing about six pounds would be appropriate for initial installation. Other applications, such as perhaps a motorcycle, would likely have a much smaller zinc body 12, perhaps one and one-half or two pounds in weight. Construction machines, such as bulldozers or cranes, may utilize even larger zinc bodies 12, perhaps even ten pound zinc bodies 12. Placement on the frame 20 of the land vehicle or machine 5, 6, 8, 9 is a matter of convenience, and can largely be placed out of sight, but not out of reach, as the zinc body 12 needs to be replaced when worn through corrosion.

Installation is rather simple in that the corrosion inhibitor device 10 is connected directly to the steel frame 20 or other steel or aluminum component without insulating the device 10 from the frame 20. The direct connection facilitates the passage of electrical current into the zinc body 12 when the vehicle is wet. The location of the attachment is a matter of choice of the owner, however, the larger the vehicle or machine, it is possible that multiple devices 10 will preferably be attached to the vehicle frame. Monitoring of the corrosion inhibitor devices 10 is also important, as the devices 10 should be checked every three months and annually to determine the remaining size of the zinc body 12. When the zinc body 12 has reduced to about half size, compared to the weight of the zinc body 12 when originally installed on the land vehicle or machine, the zinc body 12 should be replaced with a full sized zinc body 12.

It will be understood that changes in the details, materials, steps and arrangements of parts, which have been described and illustrated to explain the nature of the invention will occur to and may be made by those skilled in the art upon a reading of this disclosure within the principles of the scope of the invention. The foregoing description illustrates the preferred embodiment of the invention; however, concepts, as based upon the description may be employed in other embodiments without departing from the scope of the invention. Accordingly, the following claims are intended to protect the invention broadly, as well as in the specific form shown.

For example, the term fasteners or fastener members described above and placed in the claims can include other attachment processes, including welding, riveting or other connecting devices or processes. In addition, the zinc body 12 could be placed into a carrier (not shown) that can retain the zinc body in an electrically conductive manner while the carrier is affixed, connected, welded, riveted, etc. to the steel or aluminum component that is intended to be protected from corrosion.

Any land vehicle or machine that has an electrical system accelerates the corrosion process due to electrolysis. However, corrosion will still occur at a slower rate on equipment without an electrical system, such as snow plows, farm equipment and pipes in dairy barns, as examples.

Having thus described the invention, what is claimed is:

1. A corrosion inhibitor device for mounting on a steel or aluminum component of a land vehicle or machine operating over the surface of the land, comprising:
a zinc body adapted to be detachably connected to the steel or aluminum component of a land vehicle or machine; and
fastener members detachably connecting the zinc body to the steel or aluminum component of the land vehicle or machine so that the zinc body is electrically conductive with respect to the steel or aluminum component of said land vehicle.

2. The corrosion inhibitor device of claim 1 further comprising:
a mounting strap secured to the zinc body and engaged by said fastener members to said steel or aluminum component of the land vehicle or machine.

3. The corrosion inhibitor device of claim 2 wherein said mounting strap is integrally molded into the zinc body.

4. The corrosion inhibitor device of claim 3 wherein said fastener members are bolts that pass through holes formed in said mounting strap and aligned holes in said steel or aluminum component to secure the mounting strap to the steel or aluminum component.

5. The corrosion inhibitor device of claim 3 wherein said mounting strap extends from opposing ends of the zinc body to present mounting tabs that connect directly to said steel or aluminum component of said land vehicle or machine.

6. The corrosion inhibitor device of claim 2 wherein said mounting strap and said zinc body are separate components to enable the zinc body to be detached from said mounting strap without requiring said mounting strap to be disconnected from said steel or aluminum component.

7. The corrosion inhibitor device of claim 1 wherein said zinc body is formed with an opening passing centrally therethrough to enable said fasteners to connect said zinc body directly to said steel or aluminum component.

8. The corrosion inhibitor device of claim 1 wherein said steel or aluminum component of said land vehicle comprises the frame of said land vehicle.

9. A corrosion inhibitor device for mounting on a steel or aluminum component of a land vehicle or machine operating over the surface of the land, comprising:
a zinc body adapted to be detachably connected to the steel or aluminum component of a land vehicle or machine;
fastener members to connect the zinc body to the steel or aluminum component of the land vehicle or machine in an electrically conductive manner; and
a mounting strap molded into said zinc body and projecting from opposing ends of said zinc body to present a pair of opposing mounting tabs for engagement by said fastener members mount said zinc body to said steel or aluminum component of the land vehicle or machine in said electrically conductive manner.

10. The corrosion inhibitor device of claim 9 wherein said steel or aluminum component of the land vehicle or machine comprises the frame of said land vehicle or machine.

11. The corrosion inhibitor device of claim 10 wherein said fastener members are bolts that pass through holes formed in said mounting tabs and aligned holes formed in said steel or aluminum component to secure the mounting strap to the frame of said land vehicle or machine.

12. The corrosion inhibitor device of claim 10 wherein said mounting strap and said zinc body are separate components to enable the zinc body to be detached from said mounting strap without requiring said mounting strap to be disconnected from said frame of said land vehicle or machine.

13. The corrosion inhibitor device of claim 12 wherein said zinc body is formed with an opening passing centrally therethrough to enable said fasteners to connect said zinc body directly to said frame of said land vehicle or machine.

14. A corrosion inhibitor device for mounting on a frame of a land vehicle operating over the surface of the land, comprising:
a sacrificial metal body detachably connected to said frame of said land vehicle;
fastener members connecting the sacrificial metal body to said frame of the land vehicle in an electrically conductive manner.

15. The corrosion inhibitor device of claim 14 wherein said sacrificial metal body is formed of zinc.

16. The corrosion inhibitor device of claim 15 wherein said sacrificial zinc body is connected to a mounting strap engaged by said fastener members to said frame of said land vehicle.

17. The corrosion inhibitor device of claim 16 wherein said mounting strap is molded into said sacrificial zinc body, said mounting strap projecting from one end of said zinc body to be engaged by said fastener members for connection thereof to said frame of said land vehicle.

18. The corrosion inhibitor device of claim 16 wherein said mounting strap is molded into said sacrificial zinc body, said mounting strap projecting from opposing ends of said zinc body to present opposing mounting tabs for engagement by said fastener members and connection thereof to said frame of said land vehicle.

19. The corrosion inhibitor device of claim 16 wherein said sacrificial zinc body is detachably connected to said mounting strap.

20. The corrosion inhibitor device of claim 15 wherein said sacrificial zinc body is connected directly to said frame of said land vehicle by said fastener members.
